(19) United States
(12) Patent Application Publication
(10) Pub. No.: US 2009/0120002 A1
(43) Pub. Date: May 14, 2009

(54) DOOR OPENING AND CLOSING DEVICE

(76) Inventor: Norman L. Domholt, Minnetrista, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/205,410

(22) Filed: Sep. 5, 2008

Related U.S. Application Data
(60) Provisional application No. 60/970,826, filed on Sep. 7, 2007.

(51) Int. Cl. E05F 15/14; E05F 11/24

(52) U.S. Cl. 49/340; 49/341

(57) ABSTRACT

A door opener system for opening and closing a door relative to a structure includes a rack gear that is hinged on one end to the structure. The door opener system also includes a pinion drive mechanism that is fixed to the door. The door opener system further includes a pinion gear that is engaged with the rack gear and that is rotationally driven by the pinion drive mechanism. In addition, the door opener system includes a retention assembly supporting at least one guide bearing that is engaged with the rack gear. Additional embodiments are disclosed.

### PRIORITY INFORMATION

This application claims the benefit of U.S. Provisional Application No. 60/970,826, filed Sep. 7, 2007, the content of which is herein incorporated by reference.

### FIELD OF THE INVENTION

The invention relates to mechanisms for opening a door, and in particular, mechanisms for opening an armored door of a mobile vehicle.

### BACKGROUND OF THE INVENTION

There are various applications in which it is desired to open and close a door. In some cases, a door that needs to be opened and closed is heavier than can be readily be opened and closed manually by a person. In such cases, it is desired to have a powered door opening mechanism that can open and close the door.

One application where a door may be heavier than can be readily opened by a person is an armored door of a mobile vehicle. For example, military vehicles often operate in environments where there is a threat of projectiles, such as bullets and rockets, impacting the vehicle, as well as the threat of explosive devices such as mines and bombs detonating near the vehicle. To provide maximum protection to occupants of such a military vehicle, it is desired to provide armoring to the vehicle body. Providing armoring to the doors of the vehicle can be effective in reducing casualty rates of soldiers or other vehicle occupants who encounter a projectile or explosive attack.

However, armored doors can be very heavy. For example, in some cases, armored doors can weigh more than 300 pounds, and in other cases armored doors can weigh more than 500 pounds, and in further cases, armored doors can weight more than 800 pounds. It can be very difficult for a person to manually open and close such a door, even for a physically conditioned person such as a soldier.

A door opening and closing device should be capable of opening and closing a door in a reasonable period of time. The device should also be capable of opening a door against the full weight of the door, such as would occur if the vehicle is upset, such as by an explosive device or an accident, so that the door has to be opened straight up against gravity.

Improved constructions for door opening and closing devices are needed.

### SUMMARY OF THE INVENTION

The invention relates to a door opening and closing system for opening and closing a door relative to a structure, also called a door opener system. In one aspect, the door opener system includes a rack gear hinged on one end to the structure, wherein the rack gear includes a shaft portion that defines gear teeth on a first side, and an angled portion including the hinged end, wherein the angled portion is positioned at an angle of at least 45 degrees and not more than 160 degrees to the shaft portion. The system further includes a pinion drive mechanism fixed to the door and a pinion gear engaged with the rack gear and rotationally driven by the pinion drive mechanism. The system also includes a retention assembly supporting at least one guide bearing that is engaged with the rack gear.

Another aspect of the invention relates to an armored door system for an armored vehicle where the system also includes a rack gear configured to be hinged on one end to a vehicle structure. The rack gear includes a shaft portion that defines gear teeth on a first side and includes a second side opposite to the first side, wherein the second side is generally smooth. The rack gear further includes an angled portion including the hinged end, wherein the angled portion is positioned at an angle of at least 45 degrees and not more than 160 degrees to the shaft portion. The system further includes a pinion drive mechanism configured to be fixed to the armored door at the exterior of the vehicle and a pinion gear engaged with the rack gear and rotationally driven by the pinion drive mechanism. The system also includes a retention assembly configured to be pivotably secured to a structure associated with the armored door and supporting at least two guide bearings that are engaged with the generally smooth surface of the gear opposite to the pinion gear.

Yet another aspect of the invention is a door opener system including a rack gear hinged on one end to the structure, where the rack gear defines gear teeth on a first side, a pinion drive mechanism fixed to the door, a pinion gear engaged with the rack gear and rotationally driven by the pinion drive mechanism, and a retention assembly pivotably secured to the door and supporting at least one guide bearing that is engaged with the rack gear.

The invention may be more completely understood by considering the detailed description of various embodiments of the invention that follows in connection with the accompanying drawings.

### BRIEF DESCRIPTION OF THE DRAWINGS

FIG. 1 is a perspective view of a door opening and closing device constructed according to the principles of the present invention.

FIG. 2 is a top view of the door opening and closing device of FIG. 1 with the door in a closed position relative to a vehicle.

FIG. 3 is a top view of the door opening and closing device of FIG. 1 with the door in an open position relative to a vehicle.

FIG. 4 is a top view of a portion of a rack gear and a pinion gear and guide bearings of an embodiment of a door opening and closing device.

FIG. 5 is a perspective exploded view of a portion of the door assist device of one embodiment.

FIG. 6 is a top view of a rack gear of a door opening and closing device.

FIG. 7 is a top view of a rack gear and pinion gear in a plurality of operative positions.

FIG. 8 is a perspective exploded view of a retention assembly of a door opening and closing device.

FIG. 9 is a top view of a rack gear and a retention assembly in a plurality of operative positions.

FIG. 10 is a perspective view of a pinion drive mechanism and motor.

FIG. 11 is a perspective view of a mechanical linkage structure for connecting the pinion drive mechanism to a handle.

FIG. 12 is a front view of the door opening system.

FIG. 13 is a perspective, exploded view of another embodiment of a mechanical linkage structure for connecting the pinion drive mechanism to a handle.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

### DETAILED DESCRIPTION OF THE INVENTION

This application relates to mechanical devices for moving structures, especially doors, and more specifically a door of a vehicle. The concepts herein are especially useful for moving heavy, armored vehicle doors.

A door opening and closing system is described herein for opening and closing a door relative to a structure, such as an armored vehicle frame. The door opener system includes a rack gear hinged on one end to the structure, wherein the rack gear includes a shaft portion that defines gear teeth on a first side. The second, opposite side is smooth in profile. In some embodiments, the rack gear includes an angled portion adjacent to the hinged end. The angle defined between the angled portion and the shaft portion is typically at least 45 degrees and not more than 160 degrees. In some embodiments, the angle is about 100 degrees.

The system further includes a pinion drive mechanism fixed to the door and a pinion gear engaged with the rack gear and rotationally driven by the pinion drive mechanism. The system also includes a retention assembly supporting at least one guide bearing that is engaged with the rack gear.

In some embodiments, the retention assembly is configured to be pivotably secured to a structure associated with the armored door and supports at least two guide bearings that are engaged with the generally smooth surface of the rack gear.

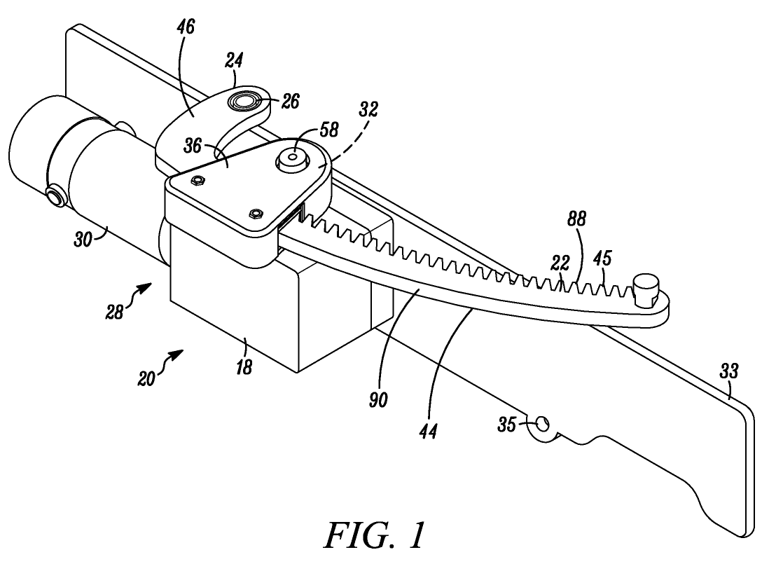

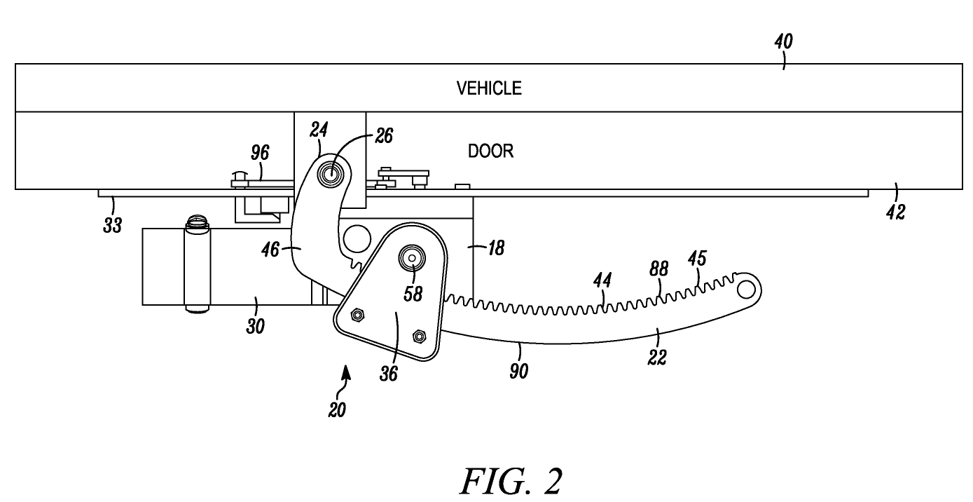

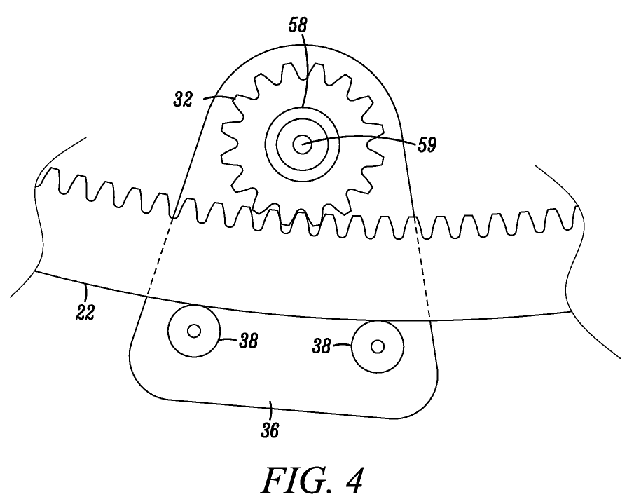

Referring now to FIG. 1, a perspective view of an embodiment of a door opening and closing device constructed according to the principles of the present invention is shown. Door opening and closing device 20, also called door opener device or door assist device, is configured to open and close a door relative to a structure. The door assist device 20 includes a rack gear 22 that is hinged proximate to first end 24 of rack gear 22 to a structure that the door is opened relative to. In some embodiments, this structure is a vehicle 40, which is shown in FIG. 2. The rack gear 22 includes hinge 26 that generally provides for the rotational motion of rack gear 22 about an axis of rotation through the center of hinge 26. A pinion drive mechanism 28 is fixed to the door and is configured to provide rotational motion to a pinion gear 32, which is illustrated in FIG. 4. Pinion gear 32 generally is secured to a pinion shaft 58. In one embodiment, pinion drive mechanism 28 includes an electrical motor 30 configured to drive a pinion gear 32 (shown in FIG. 4) and pinion shaft 58 through a mechanical gear train. In one embodiment, the pinion drive mechanism 28 includes a right angle drive mechanism, such that the axis of rotation of the pinion gear 32 is at approximately a right angle to the axis of rotation of the electrical motor 30. Pinion gear 32 is engaged with the rack gear 22 and is rotationally driven by the pinion drive mechanism 28.

In some embodiments, an enclosure 18 is provided around part or all of pinion drive mechanism 28. It is also possible for the door opening device 20 to include a plate 33 upon which many of the components are mounted, and which includes openings 35 for mounting the plate 33 to the door. It is also possible to mount some of the components directly to the door, or to accomplish the mounting using other structures.

Also shown in FIG. 1 is a retention assembly 36 that is secured to the door. In one embodiment, retention assembly 36 is pivotably secured to the door. In a particular embodiment, the retention assembly pivots about the pinion shaft 58, such that retention assembly pivots about the same center of rotation as pinion gear 32. Retention assembly 36 supports at least one guide bearing 38 (visible in FIG. 4) that is engaged with the rack gear 22. The at least one guide bearing 38 is generally positioned to engage the rack gear 22 in a location opposed to pinion gear 32, such that guide bearing 38 provides a reactionary force to rack gear 22 that opposes any forces that tend to push rack gear 22 away from pinion gear 32. Guide bearing 38 may take a number of configurations, including configurations in which the guide bearing 38 is a roller that rotates about an axis of rotation and configurations in which the guide bearing 38 does not rotate but instead provides a surface that slides along rack gear 22. For example, guide bearing 38 may be a metal pin or bar that does not rotate but that engages rack gear 22 in such a way as to prevent rack gear 22 from deflecting away from pinion gear 32 and does not prevent rack gear 22 from sliding relative to guide bearing 38. Guide bearing 38 generally ensures that rack gear 22 remains engaged with pinion gear 32. Various embodiments have one guide bearing, two guide bearings as shown in the Figures, or more than two guide bearings.

FIG. 2 is a top view of a door opener assist device 20 operatively mounted to a vehicle 40 and a door 42. In FIG. 2, door 42 is in a closed position such that it is generally brought up against vehicle 40. It is desired that rack gear 22 be brought up relatively close to vehicle 40 when door 42 is in the closed position, such that rack gear 22 does not protrude excessively from vehicle 40. If rack gear 22 were to protrude excessively from vehicle 40, it would increase the risk that rack gear 22 would be damaged or could impact objects as vehicle 40 moves. In the embodiment of FIG. 2, rack gear 22 has a shaft portion 44 that defines gear teeth on a first side 45. In addition, rack gear 22 has an angled portion 46 proximal to hinged end 24. The angled portion 46 is a relatively short section compared with the shaft portion. The angled portion 46 that has a general longitudinal orientation that is angled with respect to the general longitudinal orientation of the toothed shaft segment 44 of rack gear 22.

FIGS. 1-3 show the door opening system 20 mounted on a left-side vehicle door 42. The mirror image of the door opening system 20 can be used for a right-side vehicle door.

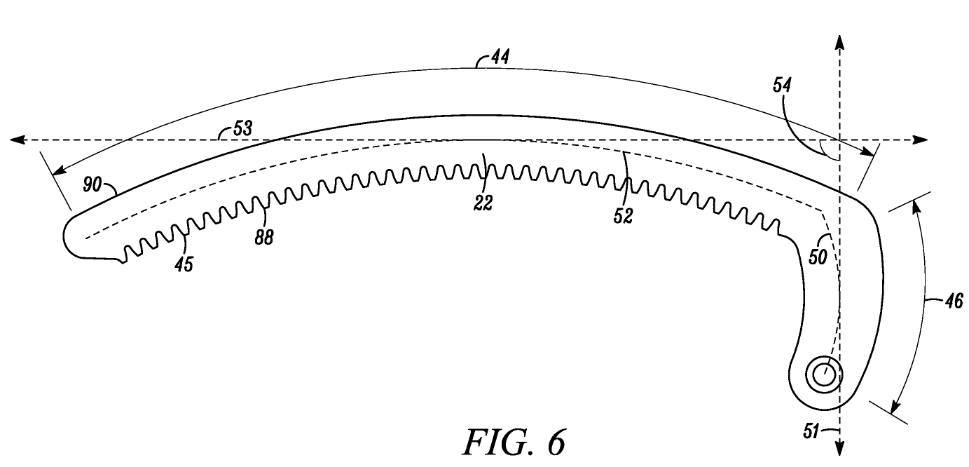

FIG. 6 is a top view of the rack gear. Each of angled section 46 and shaft section 44 are characterized by a length, such as the length from one end of the section to the other end of the section as measured along the centerline of the section. In some embodiments, the length of the angled portion 46 is less than about 25 percent of the length of shaft section 44 of rack gear 22, and in other embodiments, the length of the angled section 46 is less than about 15 percent of the length of toothed section 44.

The angled section 46 defines a centerline 50 and the toothed segment 44 defines a centerline 52. The angled section 46 is defined by a relatively pronounced change in orientation from centerline 52 to centerline 50. In the embodiment illustrated in FIG. 6, both the shaft portion and angled portion of the rack gear are curved. It is also possible for those portions to be straight, though the device 20 would protrude farther as a result. As shown in FIG. 6, the change in orientation from centerline 52 to centerline 50 forms an angle 54. The angle 54 can be determined by defining a tangent line 51 to the curved centerline 50 of the angled portion, at its midpoint, and defining a tangent line 53 to the curved centerline 52 of the shaft portion, at its midpoint, and then measuring the angle 54 formed between the tangent lines 51, 53. In some embodiments, angle 54 is an acute angle, and in other embodiments, angle 54 is a right angle, and in further embodiments, angle 54 is an obtuse angle. In some embodiments, angle 54 is between 45 and 160 degrees, whereas in other embodiments the angle is between 90 and 160 degrees. Generally, the length of the angled portion 46 and the angle 54 define a characteristic in which rack gear 22 folds in against vehicle when door is in a closed position and swings away from vehicle when door is being opened. The angled portion 46 also positions rack gear 22 at sufficient distance from vehicle so that there is clearance for pinion gear 32 between vehicle and rack gear 22 when the door is in the closed position of FIG. 2.

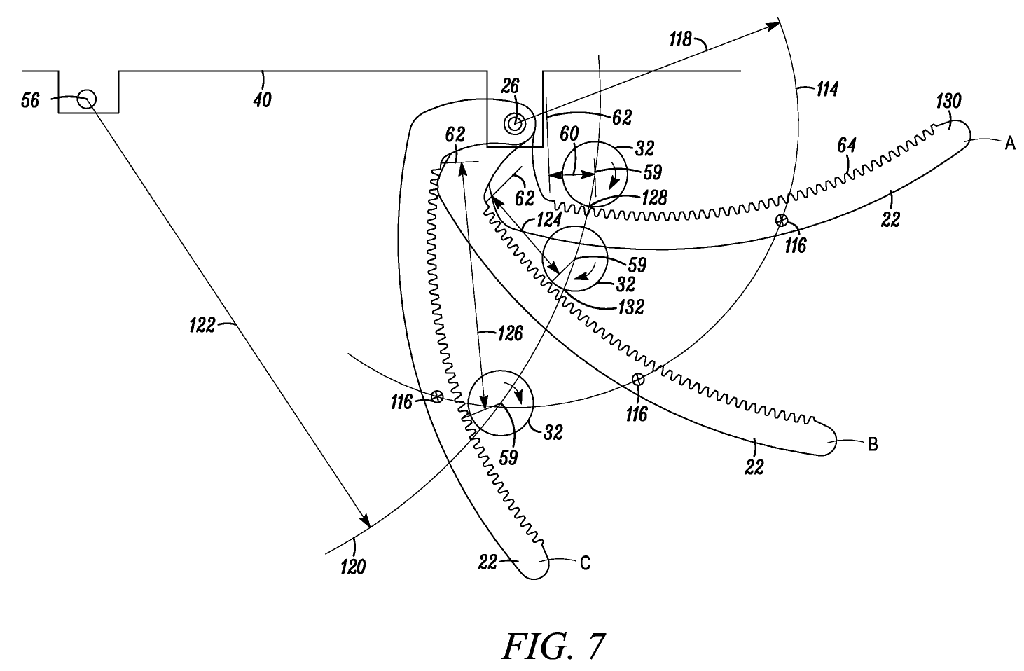

The position of rack gear 22 relative to vehicle 40 is shown in FIG. 7 for three different positions of pinion gear 32. For simplicity of illustration, FIG. 7 shows only the vehicle 40, rack gear 22, and pinion gear 32 in each of three positions A, B, and C. The door 42 is not illustrated in FIG. 7, although the door 42 can be seen in closed position A in FIG. 2. Now referring to FIG. 7, in position A, door and rack gear 22 are in a closed position; in position B door 42 and rack gear 22 are in a beginning of opening position; and in position C door 42 and rack gear 22 are in an intermediate opening position. Generally, rack gear 22 moves along an arc such as arc 114 with its center at hinge 26. Arc 114 is the arc that point 116 on rack gear 22 will travel as rack gear 22 rotates about hinge 26. Arc 114 defines a radius 118 of point 116 about hinge 26. Each point on rack gear 22 will have a unique radius about hinge 26, but each radius will be of constant length owing to the fact that rack gear 22 is constrained to only rotate about hinge 26.

Similarly, pinion 32 (more specifically, pinion axis 59) follows an arc 120 with its center at door hinge 56 and having a radius 122. Pinion 32 is configured to rotate on pinion axis 59, but pinion axis 59 is fixed in relation to the door 42, such that pinion axis 59 travels along arc 120 about door hinge 56 as the door opens and closes. The position of rack gear 22 along arc 114 and of pinion axis 59 along arc 120 is determined by the position of pinion gear 32 along toothed segment 64 of rack gear 22. For a given position of pinion gear 32 along rack gear 22, both pinion axis 59 and point 116 of rack gear 22 must fall somewhere along their respective arcs of motion 120, 118. The position of door 42 follows the position of pinion axis 59. The position of pinion gear 32 along toothed segment 64 is controlled by rotation of pinion gear 32. Rotation of pinion gear 32 is effected by pinion drive mechanism 28, which is depicted in FIG. 1. In this way, pinion drive mechanism 28 controls the position of door 42.

In position A of FIG. 7, pinion gear 32 contacts rack gear 22 at a distance 60 from the forward end 62 of toothed segment 64 of rack gear 22. In this configuration, to open the door, pinion gear 32 is rotated clockwise as viewed from the top (and as seen in FIG. 7). For a fixed incremental rotation of pinion gear 32, a fixed translational distance occurs of pinion gear 32 relative to rack gear 22. However, because pinion gear 32 is constrained to move only along arc 120 through pinion axis 59, and because rack gear 22 is constrained to move only along an arc such as arc 114, translational movement of pinion gear 32 relative to rack gear 22 results in rotation of rack gear 22 about hinge 26 and rotation of pinion axis 59 about door hinge 56. In position A, where door 42 and rack gear 22 are in a closed position A, pinion axis 59 is relatively close to hinge 26. A given rotation of pinion 32 along rack gear 22 will result in a given translation of pinion 32 along rack gear 22. This translation will require pinion axis 59 to travel along arc 120 and for rack gear 22 to travel along its corresponding arc. However, because the point of contact 128 between pinion gear 32 and rack gear 22 is relatively close to hinge 26, a given movement of pinion axis 59 along radius 120 will tend to result in a much greater motion of far end 130 of rack gear 22. While pinion gear 32 and rack gear 22 are constrained to move the same distance at their point of contact 128, the much smaller radius of the arc of motion at the point of contact 128 of rack gear 22 compared to the radius of the arc of motion of pinion axis 59 will result in the motion of the far end 130 of rack gear moving a greater distance. This effect causes rack gear 22 to swing out and away from vehicle 40 relatively quickly during the initial opening movement of pinion gear 32. As pinion 32 moves down rack gear 22, the radius from hinge 26 to the point of contact, such as point 132, increases. As this radius increases, a given translation of pinion 32 will result in relatively less angular translation of rack gear 22 and relatively greater angular translation of door 42. Therefore, when door 42 is being opened from the closed position, the first movement of pinion 32 will tend to cause rack gear 22 to swing out quickly. Likewise, when door 42 is being closed, the final movement of pinion 32 will tend to cause rack gear 22 to fold up tightly against vehicle 40.

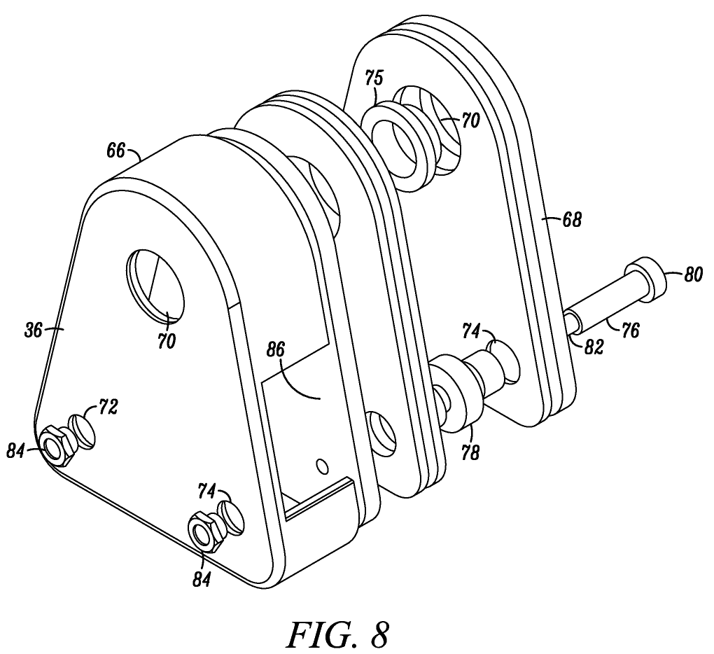

Retention assembly 36 is shown in FIG. 1 as a part of door opener assist device 20. FIG. 8 shows an embodiment of a retention assembly 36 in an exploded view. In the embodiment of FIG. 8, retention assembly 36 includes a housing 66 and a base 68. Each of housing 66 and base 68 define pinion shaft openings 70 and guide bearing shaft openings 72, 74. The guide bearing shaft opening 72 of the base 68 is not visible in FIG. 8. Pinion shaft openings 70 are configured to receive pinion shaft of pinion gear 32. In some embodiments, pinion shaft turns directly in pinion shaft openings 70. In some other embodiments, pinion shaft bushings 75 are provided that engage with pinion shaft openings 70 and provide a surface that pinion shaft rotates against.

In some embodiments, at least one guide bearing shaft 76 is provided and is configured to pass through a guide bearing shaft opening, such as guide bearing shaft opening 72 or guide bearing shaft opening 74. In some embodiments, a guide bearing roller 78 is provided that is configured to rotate on guide bearing shaft 76. In some embodiments, guide bearing shaft 76 has a head 80 at one end that is configured to be supported by base 68 and has a threaded length 82 that is configured to project through guide bearing shaft openings 72, 74 and to be secured by a threaded nut 84 that is supported by housing 66. Retention assembly 36 defines a pair of rack gear clearance openings 86 that are configured to allow the rack gear 22 to pass through retention assembly 36. One such opening 86 is visible in FIG. 8, while one is not visible. Retention assembly 36 pivots about the pinion shaft 58, as depicted in FIG. 1, as the pinion gear 32 moves along rack gear 22.

The ability of retention assembly 36 to pivot about pinion shaft 58 allows for the retention assembly to accommodate variability in the angle of rack gear 22 relative to the door 42, and thus also relative to pinion gear 32. Variability in the angle of rack gear 22 to the pinion gear 32 occurs as the door 42 is opened. Because of the presence of the angled portion 46, as well as the differences in the radius of the arc around which the door opens (radius 122 in FIG. 7), the radius around which the rack gear rotates (such as radius 114 of FIG. 7), and the radius defined by the gear teeth 88 of rack gear 22 around which the pinion gear 32 rotates, the angle of the rack gear relative to the body changes at a different rate than the angle of the rack gear 22 relative to the door 42 (and pinion gear 32) as the door opens. As a consequence, in order for the retention assembly 36 to accommodate variability in the angular orientation of the rack gear 32 to the pinion gear 32, the retention assembly 36 is configured to pivot about pinion shaft 58. If retention assembly 36 did not pivot, the pivot assembly 36 and rack gear 22 might bind at some point in the range of motion.

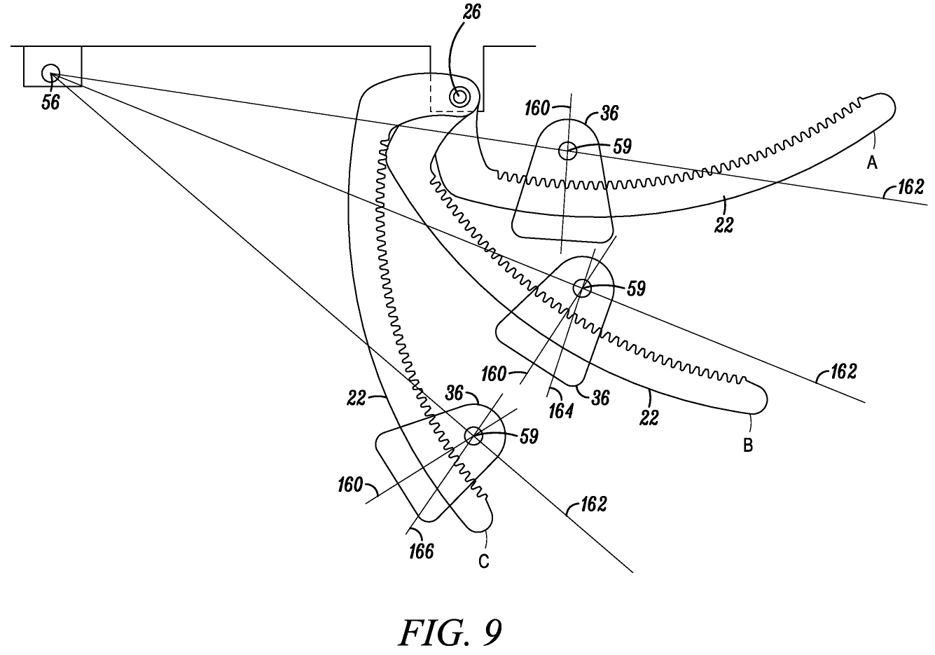

The pivoting action of retention assembly 36 is shown in FIG. 9. Retention assembly 36 is shown in three operative positions corresponding to three positions of rack gear 22. These three positions are labeled A, B, and C. Position A corresponds to a position with door 42 in or near a closed position relative to vehicle 40. Position B corresponds to an intermediate position of door 42, and position C corresponds to door 42 being in a close to fully open position. As discussed above in reference to FIG. 7, pinion axis follows an arc having its center at door hinge 56 and rack gear 22 follows an arc having its center at hinge 26. Retention assembly 36 follows an arc having its center at pinion axis 59. As seen on FIG. 9, retention assembly 36 has a line of symmetry 160 that generally serves to define the orientation of retention assembly 36. A line 162 is drawn on FIG. 7 for each position and extends through door hinge 56 and pinion axis 59. Therefore, line 162 represents the approximate position of door 42, since door 42 rotates about door hinge 56 and because pinion axis 59 is maintained in a constant orientation relative to door 42. In position A, line of symmetry 160 is generally perpendicular to line 162. However, as can be seen, as pinion gear 32 progresses along rack gear 22 and door 42 moves toward an open position, the angular relationship of retention assembly 36 relative to line 162 changes. In position B, line 164 is perpendicular to line 162, and in position C, line 166 is perpendicular to line 162. As pinion gear 32 moves along rack 22, the angle defined between line 160 and lines 164 and 166 increases. This is the angular rotation of retention assembly 36 relative to door 42 and to pinion 32. The construction of retention assembly 36 that allows it to pivot around pinion axis 59 allows this change in angular orientation to be accommodated, and therefore allows the retention assembly 36 to properly engage with the rack gear 22 without binding throughout the range of motion of rack gear 22.

The rack gear 22 is visible in perspective view in FIG. 1 and in a top view in FIG. 6. As stated above, rack gear 22 includes toothed segment 44. Toothed segment 44 is characterized by gear teeth 88 along the concave surface of the rack gear 22. Generally smooth surface 90 is a surface opposite to the surface having gear teeth 88. Generally smooth surface 90 is a convex surface that is configured to engage with one or more guide bearings 38. In one embodiment, generally smooth surface 90 is the outer profile of rack gear 22. However, other embodiments are usable. For example, a groove could be provided along the length of toothed segment 44 of rack gear 22, such that one or more of the internal surfaces of the groove constitute generally smooth surface 90.

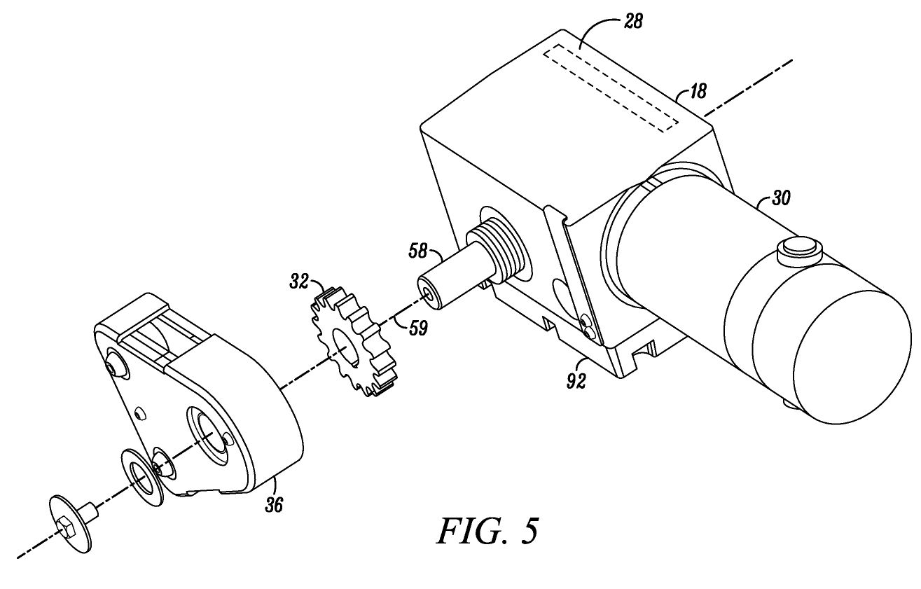

Now referring to FIG. 5, the pinion drive mechanism 28 includes a mechanical gear train within the housing 18 for transmitting power from an electrical motor 30 to pinion gear 32. The housing 18 includes a cover 92. Electrical motor 30 causes a motor shaft to rotate, which in turn causes a gear train to rotate. There are many different ways that such a gear train could be configured, and the gear train is not visible in the drawings. In one embodiment, the gear train includes two gears at right angles to each other. The gear train transmits rotation to the pinion shaft 58. In one embodiment, electrical motor 30 is a 24 volt motor. A mechanical power transmission path is accomplished from electrical motor 30 to pinion gear 32. In one embodiment, a gear reduction ratio is defined by the mechanical power transmission path. In an embodiment, this gear reduction ratio is on the order of 50:1, such that motor 30 makes about 50 revolutions for each revolution of pinion gear 32.

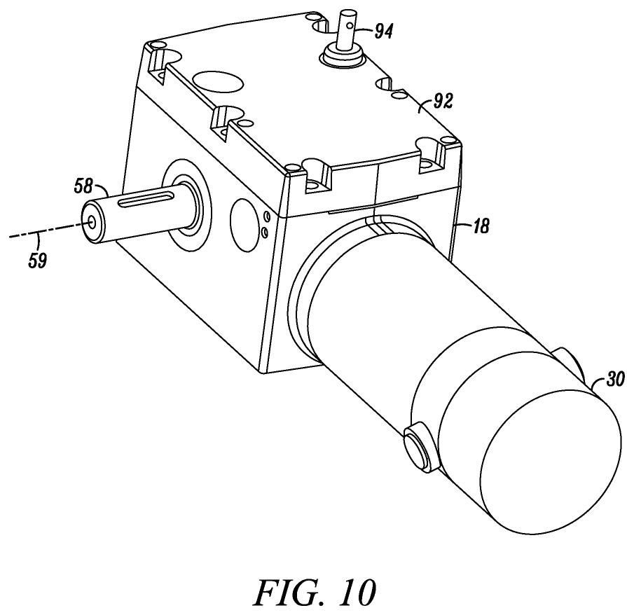

In some embodiments, a mechanical disconnect is provided to be able to mechanically uncouple the electrical motor 30 from pinion gear 32. This is advantageous in circumstances where the door needs to be opened or closed and some aspect of the door opener assist device 20 is not functioning properly. For example, the electrical supply system could be damaged or non-functional. It is advantageous to be able to open and close the door manually despite such a failure. There are many different configurations that can provide a mechanical disconnection function to allow manual operation of the door system. One example of a mechanical disconnection system is in the Figures. FIG. 10 is a view of the housing 18 with the cover 92 facing up, where a mechanical disconnect pin 94 is visible emerging from the cover 92. The mechanical disconnect pin includes a paddle shape on the end that it within the housing 18, where the paddle shape moves one component of the gear train out of engagement with the motor when the disconnect pin 94 is turned.

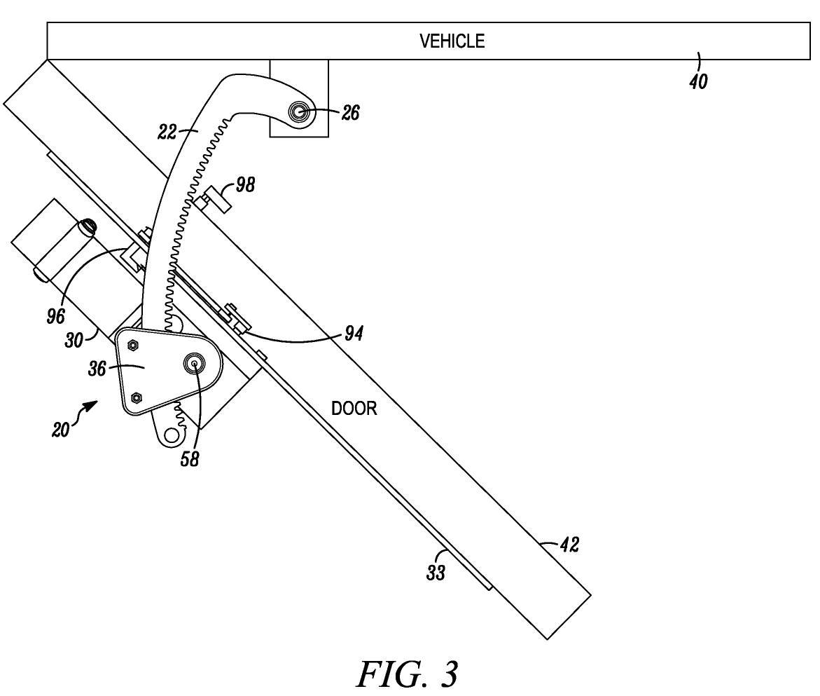

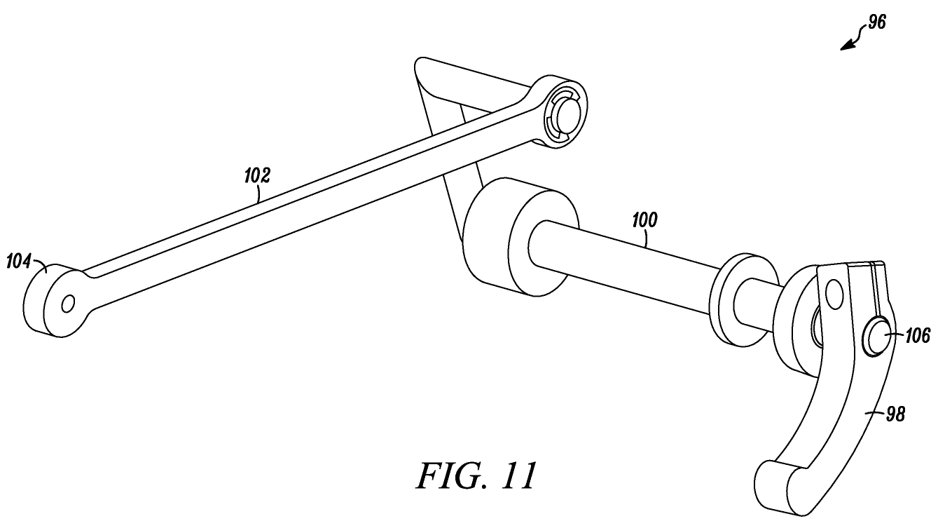

The system can include a variety of linkages to enable an occupant of the vehicle to turn mechanical disconnect pin 94. For example, FIG. 11 illustrates a linkage structure 96 that includes a handle 98 that is configured to be positioned within the vehicle cab and be accessible to an occupant of the vehicle. Handle 98 is also visible in the top view of FIG. 3. Again referring to FIG. 11, the handle 98 is attached to a lever 100 which is in turn connected to a linkage 102. One end 104 of the linkage 102 is configured to attach to the disconnect pin 94. When the handle 98 is pivoted about a pivot point 106, then the lever 100 and linkage 102 cause the disconnect pin 94 to rotate, taking the pinion gear out of engagement with the motor shaft. FIG. 3 illustrates that the handle 98 is positioned on an interior side of the door 42, and the lever 100 extends through the door structure to provide the connection to the remainder of the door opening system 20.

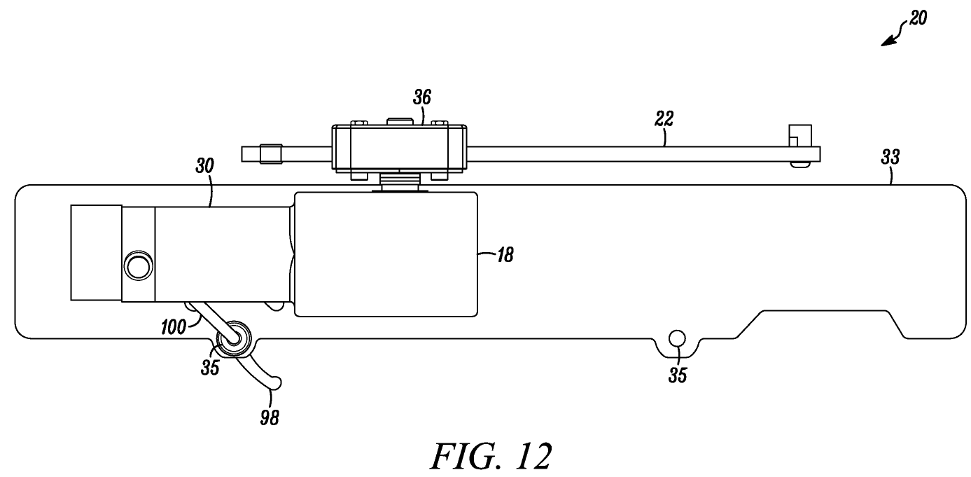

FIG. 12 is a front view of the door opening system 20, where the handle 98 is visible below the plate 33. The lever 100 passes through the bolt opening 35. In one embodiment, the plate 33 is bolted to the door near the top of the door, so that much of the plate 33 extends above the door.

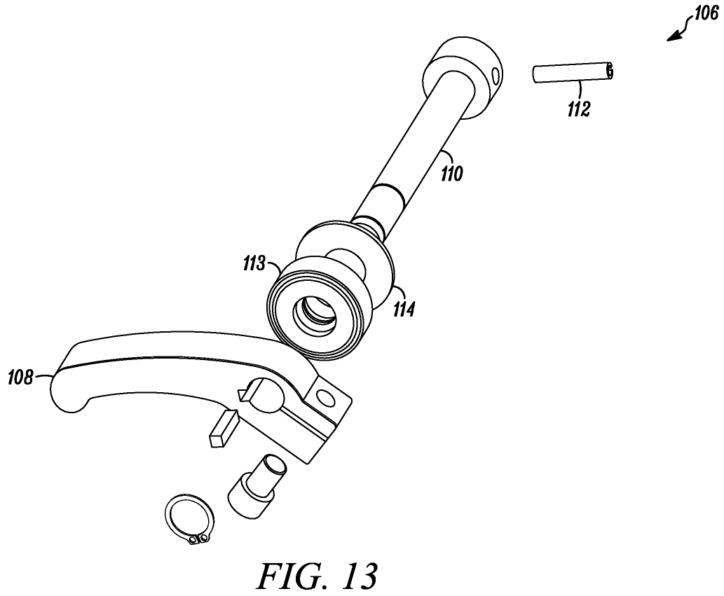

As mentioned above, there are many options for configuring a mechanical disconnection structure for a door opening device. One additional example of a mechanical disconnection structure 106 is shown in FIG. 13. In this embodiment, the disconnection structure 106 includes a handle 108, a shaft 110, and a taper pin 112 for engaging with a disconnect pin 94 that protrudes from the housing of the pinion drive mechanism. The linkage structure 106 also includes a seal 113 and an adhesive disk 114 for helping to adhere the seal 113 to the door 42.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

The above specification provides a complete description of the structure and use of the invention. Since many of the embodiments of the invention can be made without parting from the spirit and scope of the invention, the invention resides in the claims.

What is claimed is:

1. A door opener system for opening and closing a door relative to a structure, the door opener system comprising:
(i) a rack gear hinged on one end to a structure, wherein the rack gear includes:
(a) a shaft portion that defines gear teeth on a first side, and
(b) an angled portion including the hinged end, wherein the angled portion is positioned at an angle of at least 45 degrees and not more than 160 degrees to the shaft portion;
(ii) a pinion drive mechanism fixed to a door;
(iii) a pinion gear engaged with the rack gear and rotationally driven by the pinion drive mechanism; and
(iv) a retention assembly supporting at least one guide bearing that is engaged with the rack gear.

2. The door opener system of claim 1 wherein the retention assembly is pivotably secured to the door.

3. The door opener system of claim 1, where the retention assembly pivots on the pinion drive mechanism.

4. The door opener system of claim 3, where the retention assembly pivots about the pinion gear.

5. The door opener system of claim 4, where the at least one guide bearing is in an opposed relation to the pinion gear.

6. The door opener of claim 1, where the shaft portion of the rack gear further defines a second side opposite to the first side having gear teeth, wherein the second side is generally smooth.

7. The door opener of claim 6, where the at least one guide bearing engages with the generally smooth side of the rack gear.

8. The door opener of claim 1 wherein the angled portion of the rack gear is curved.

9. The door opener of claim 1 wherein the shaft portion of the rack gear is curved.

10. The door opener of claim 9 wherein the gear tooth side of the shaft portion includes a portion that is concave toward the structure in its curvature.

11. An armored door opening system for opening an armored door of an armored vehicle, the armored door opening system comprising:
(i) a rack gear configured to be hinged on one end to a vehicle structure, wherein the rack gear includes:
(a) a shaft portion that defines gear teeth on a first side and includes a second side opposite to the first side, wherein the second side is generally smooth, and
(b) an angled portion including the hinged end, wherein the angled portion is positioned at an angle of at least 45 degrees and not more than 160 degrees to the shaft portion;
(ii) a pinion drive mechanism configured to be fixed to the armored door at the exterior of the vehicle;
(iii) a pinion gear engaged with the rack gear and rotationally driven by the pinion drive mechanism; and
(v) a retention assembly configured to be pivotably secured to a structure associated with the armored door and supporting at least two guide bearings that are engaged with the generally smooth surface of the rack gear.

12. The armored door system of claim 11, where the retention assembly pivots about an axis that is generally coaxial with an axis of rotation of the pinion gear.

13. The armored door system of claim 11, where the pinion drive mechanism comprises an electrical motor.

14. The armored door system of claim 13, where the electrical motor selectively receives electrical current from a vehicle electrical system and a back-up battery.

15. The armored door system of claim 13, further comprising a manually-actuatable feature to disengage the pinion gear from the electric motor and allow the pinion gear to freewheel independently of the electric motor.

16. A door opener system for opening and closing a door relative to a structure, the door opener system comprising:
(i) a rack gear hinged on one end to a structure, wherein the rack gear defines gear teeth on a first side;
(ii) a pinion drive mechanism fixed to a door;
(iii) a pinion gear engaged with the rack gear and rotationally driven by the pinion drive mechanism; and
(iv) a retention assembly pivotably secured to the door and supporting at least one guide bearing that is engaged with the rack gear.

17. The armored door system of claim 16, where the retention assembly pivots about an axis that is generally coaxial with an axis of rotation of the pinion gear.

18. The door opener system of claim 16, where the at least one guide bearing is in an opposed relation to the pinion gear.

19. The door opener of claim 16, where the shaft portion of the rack gear further defines a second side opposite to the first side having gear teeth, wherein the second side is generally smooth, where the at least one guide bearing engages with the generally smooth side of the rack gear.
